(19) United States
(12) Patent Application Publication
(10) Pub. No.: US 2006/0053419 A1
(43) Pub. Date: Mar. 9, 2006

(54) Method and system for modifying installation software

(75) Inventors: Janel G. Barfield, Round Rock, TX (US); Julie Levell Craft, Austin, TX (US); Virginia Ann Wigginton, Round Rock, TX (US); Andrew Loung Wong, Georgetown, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/937,668

(22) Filed: Sep. 9, 2004

(51) Int. Cl. G06F 9/44

(52) U.S. Cl. 717/173

(57) ABSTRACT

Method, system and computer program product for modifying installation software in a data processing system. Installation software is stored on a rewritable data storage medium using a file system that allows portions of software stored on the rewritable data storage medium to be modified without modifying other portions of the software stored on the rewritable data storage medium. At least one portion of the stored installation software is modified to provide modified installation software on the rewritable data storage medium. The invention enables modifications to installation software to be selectively placed on the same data storage medium that stores the installation software.

### BACKGROUND OF THE INVENTION

1. Technical Field

The present invention relates generally to the data processing field and, more particularly, to a method, system and computer program product for modifying installation software in a data processing system.

2. Description of Related Art

Installation software, including the operating system and utility programs that manage computer resources, is typically stored and shipped to users on CDs (Compact Discs); and a complete installation software package can require a set of six or more CDs.

Frequently, modifications or “fixes” are made to installation software, and these modifications can be provided to users of the installation software in several ways. For example, a new installation software package incorporating the modifications can be created and shipped to users on a new set of CDs. This procedure, however, is undesirable because of the cost of the new CDs and the costs associated with shipping the new set of CDs to users each time modifications are made to the installation software.

A more common procedure for providing modifications to users of installation software is to provide users with only the modifications to the installation software. The modifications can be provided on one or more separate CDs that are shipped to users, or the modifications can be provided on a web site, and users can download the modifications and either use the modifications as a file, or store the modifications on one or more blank CDs.

Although procedures that provide users with only modifications to installation software avoid the necessity of creating and shipping complete modified installation software packages, the procedures are still not fully satisfactory because users must maintain the modifications in separate files or on separate storage media from the storage medium on which the original installation software is stored. Particularly as an increasing number of modifications become available over time, the necessity of maintaining separate files or separate storage media can become cumbersome and inconvenient to the user.

It would, accordingly, be desirable to provide a mechanism in a data processing system that enables a user to modify installation software by placing modifications to the installation software on the same storage medium that stores the installation software.

### SUMMARY OF THE INVENTION

The present invention provides a method, system and computer program product for modifying installation software in a data processing system. Installation software is stored on a rewritable data storage medium using a file system that allows portions of software stored on the rewritable data storage medium to be modified without modifying other portions of the software stored on the rewritable data storage medium. At least one portion of the stored installation software is modified to provide modified installation software on the rewritable data storage medium. The invention enables modifications to installation software to be selectively placed on the same data storage medium that stores the installation software.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram that illustrates a data processing system that may be implemented as a server in accordance with a preferred embodiment of the present invention;

FIG. 3 is a block diagram that illustrates a data processing system in which the present invention may be implemented; and

FIG. 4 is a flowchart that illustrates a method for modifying installation software in a data processing system in accordance with a preferred embodiment of the present invention.

### DETAILED DESCRIPTION OF THE PREFERRED EMBODIMENT

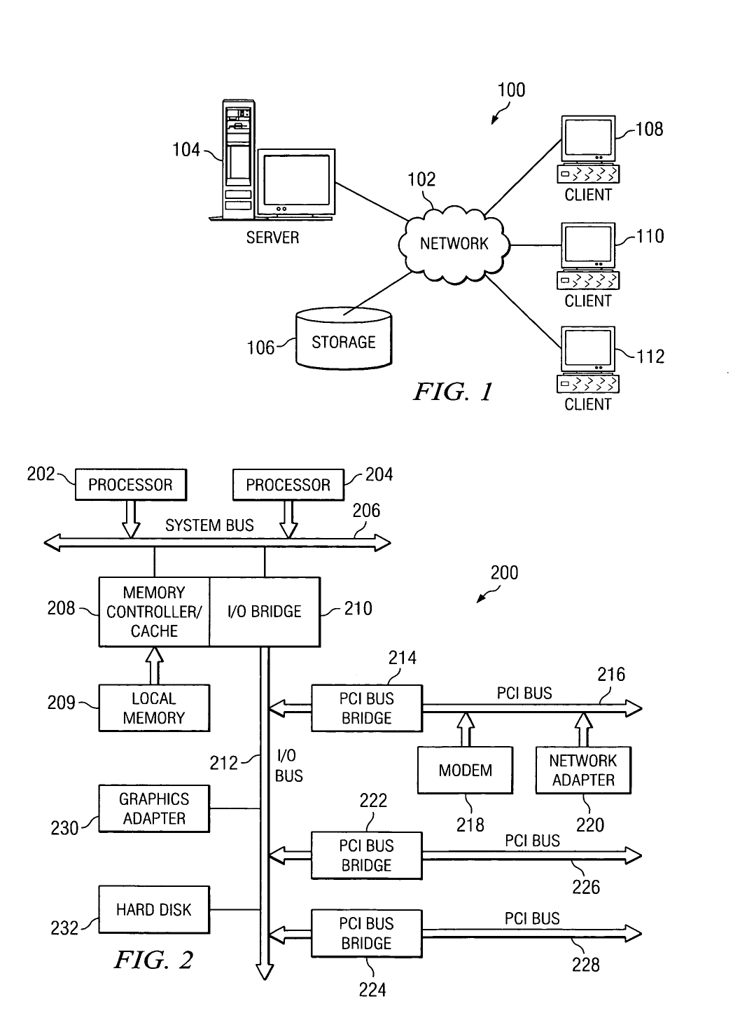

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pseries system, a product of International Business Machines Corporation in Armonk, N.Y., running the Advanced Interactive Executive (AIX) operating system or LINUX operating system.

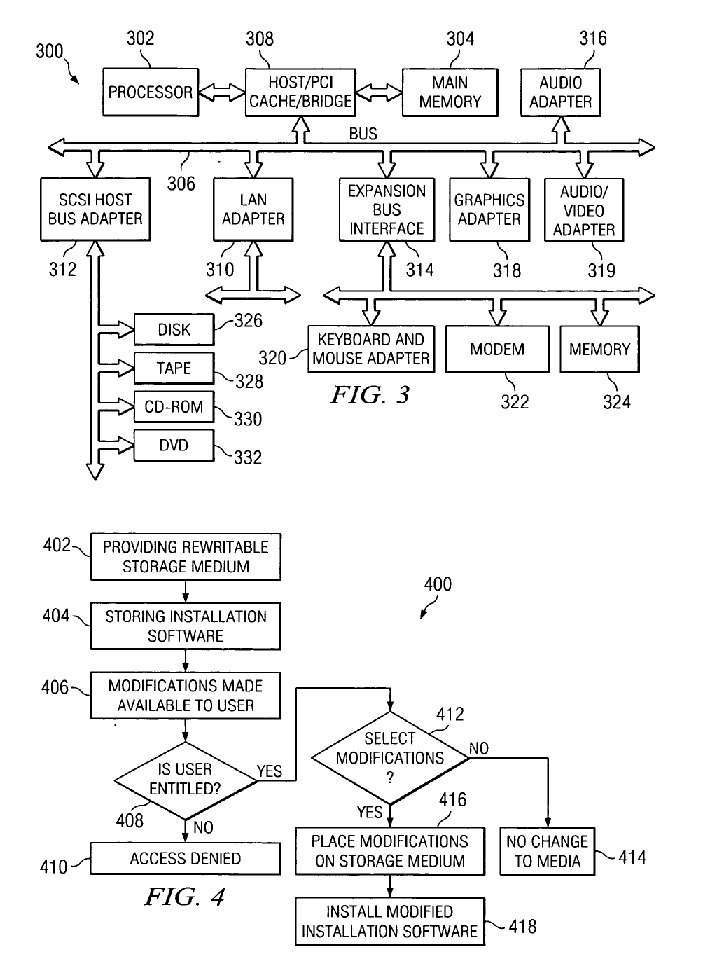

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, CD-ROM drive 330 and DVD drive 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provide a mechanism in a data processing system, such as data processing system 300 illustrated in FIG. 3, that enables a user to modify installation software by placing modifications to the installation software on the same storage medium that stores the installation software.

FIG. 4 is a flowchart that illustrates a method for modifying installation software in accordance with a preferred embodiment of the present invention. The method is generally designated by reference number 400, and begins by providing a rewritable data storage medium (Step 402). The rewritable data storage medium is preferably a DVD, such as a DVD−RAM, DVD−RW or DVD+RW, although other rewritable data storage media may also be utilized.

Installation software is then stored on the rewritable data storage medium using the Universal Disk Format (UDF) file system or another file system that allows one or more portions of software stored on the rewritable data storage medium to be modified without modifying other portions of the software stored on the rewritable data storage medium (Step 404). The installation software may be placed on the rewritable data storage medium by a supplier of the installation software and delivered to a user, or the user may place the installation software on the rewritable data storage medium, for example, by downloading the installation software as a file and placing the downloaded installation software on the rewritable data storage medium.

It is then assumed that one or more modifications or fixes have been made to the installation software, and that the modifications are being made available to users of the installation software (Step 406). Users are notified of the availability of the modifications in some suitable manner, such as directly via E-mail or ordinary mail, or indirectly by a general announcement, for example, on the supplier's web site.

The modifications to the installation software are made available to users by being posted on a web site or via E-mail. Preferably, however, only authorized users will be permitted to download the modifications. An authorized user may, for example, include any current user of the installation software, or only those users who have paid a subscription fee to the supplier to obtain modifications as they become available. Accordingly, when a user seeks access to the modifications, a determination is made if the user is an authorized user (Step 408). If the user is not an authorized user (No output of Step 408), access to the modifications is denied (Step 410).

If the user is an authorized user (Yes output of Step 408), the user then decides whether or not to select any of the available modifications for downloading (Step 412). To assist the user in deciding whether or not to download any of the available modifications, the user may execute an application that compares the installation software currently stored on the user's data storage medium with the modifications that are available to be downloaded and identify differences therebetween. Based on the identified differences, the user may decide not to select any of the available modifications (No output of Step 412), in which case no changes are made to the installation software stored on the user's data storage medium (Step 414). Alternatively, the user may decide to select any one or more or all of the available modifications (Yes output of Step 412).

If the user decides to select any of the available modifications (Yes output of Step 412), the selected modifications are downloaded into a file and placed on the user's rewritable data storage medium to provide modified installation software on the rewritable data storage medium (Step 416).

After the selected modifications are made to the installation software stored on the rewritable data storage medium, the modified installation software is then available to be installed and used by the user (Step 418).

The present invention thus provides a method, system and computer program product for modifying installation software in a data processing system. Installation software is stored on a rewritable data storage medium using a file system that allows portions of software stored on the rewritable data storage medium to be modified without modifying other portions of the software stored on the rewritable data storage medium. At least one portion of the stored installation software is modified to provide modified installation software on the rewritable data storage medium.

The invention enables modifications to installation software to be placed on the same data storage medium that stores the installation software. In addition, the user has the flexibility to decide which available modifications, if any, should be placed on the rewritable data storage medium.

The present invention also provides significant advantages to a supplier of installation software in that the supplier no longer needs to provide modifications to the installation software on separate storage media or to ship the separate storage media to users. Also, a DVD is capable of storing substantially more data than a CD, thus allowing the supplier to place the installation software on fewer disks. Also, suppliers usually prefer to place all the base operating system software on a single disk and the greater capacity of a DVD permits this to be accomplished more easily.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for modifying installation software, the method comprising:
storing installation software on a rewritable data storage medium using a file system that allows portions of software stored on the rewritable data storage medium to be modified without modifying other portions of the software stored on the rewritable data storage medium;
downloading at least one modification to the stored installation software; and
placing the downloaded at least one modification to the stored installation software on the rewritable data storage medium to provide modified installation software on the rewritable data storage medium.

2. The method according to claim 1, wherein the rewritable data storage medium comprises at least one DVD.

3. The method according to claim 1, wherein the file system comprises a Universal Disk Format file system.

4. The method according to claim 1, wherein downloading at least one modification to the stored installation software includes:
selecting the at least one modification to the stored installation software to be downloaded.

5. The method according to claim 4, wherein selecting the at least one modification to the stored installation software to be downloaded includes:
comparing the installation software stored on the rewritable data storage medium with modifications that are available to be downloaded; and
selecting the at least one modification to the stored installation software to be downloaded based on the comparison.

6. The method according to claim 4, and further including authorizing a user to select the at least one modification to the stored installation software to be downloaded.

7. The method according to claim 1, and further including using the modified installation software.

8. The method according to claim 1, wherein storing installation software on the rewritable data storage medium comprises:
storing the installation software on the rewritable storage medium by one of a supplier of the installation software and a user of the installation software.

9. A system for modifying installation software in a data processing system, comprising:
a rewritable data storage medium having installation software stored thereon using a file system that allows portions of software stored on the rewritable data storage medium to be modified without modifying other portions of the software stored on the rewritable data storage medium; and
a mechanism for modifying at least one portion of the stored installation software to provide modified installation software on the rewritable data storage medium.

10. The system according to claim 9, wherein the rewritable data storage medium comprises at least one DVD.

11. The system according to claim 9, wherein the file system comprises a Universal Disk Format file system.

12. The system according to claim 9, and further including an application for comparing the installation software stored on the rewritable data storage medium with available modifications to the installation software, wherein the mechanism for modifying at least one portion of the stored installation software modifies the at least one portion of the stored installation software by placing at least one available modification on the rewritable data storage medium on the basis of the comparison.

13. A computer program product in a computer readable medium for modifying installation software stored on a rewritable data storage medium using a file system that allows portions of software stored on the rewritable data storage medium to be modified without modifying other portions of the software stored on the rewritable data storage medium, the computer program product comprising:
first instructions for downloading at least one modification to the stored installation software; and
second instructions for placing the downloaded at least one modification to the stored installation software on the rewritable data storage medium to provide modified installation software on the rewritable data storage medium.

14. The computer program product according to claim 13, wherein the first instructions include:
third instructions for selecting the at least one modification to the stored installation software to be downloaded.

15. The computer program product according to claim 14, wherein the third instructions includes:
fourth instructions for comparing the installation software stored on the rewritable data storage medium with modifications that are available; and
fifth instructions for selecting at least one modification to the stored installation software to be downloaded based on the comparison.

16. The computer program product according to claim 14, and further including:
sixth instructions for authorizing a user to select the at least one modification to the stored installation software to be downloaded.
